(19) United States
(12) Patent Application Publication
(10) Pub. No.: US 2008/0258423 A1
(43) Pub. Date: Oct. 23, 2008

(54) VERTICAL-TUBE-FIXING-BASE STRUCTURE OF THE FORK TUBE OF THE BIKE

(76) Inventor: Yuan-Hsin HUANG, Yongjing Township (TW)

Correspondence Address: RABIN & BERDO, P.C., Suite 500, 1101 14th Street, N.W., Washington, DC, 20005, US

(21) Appl. No.: 11/736,756

(22) Filed: Apr. 18, 2007

(51) Int. Cl. B62K 21/00

(52) U.S. Cl. 280/276

(57) ABSTRACT

The present invention relates to an vertical-tube-fixing-base structure of the front fork tube of the bike and aimed at providing an direct piercing-through hole of said vertical-tube-fixing-base, which is designed to be mounted on the carbon-fiber-made front fork tube; then clip the horizontally-arranged handle via the fillister and the fixing-base-cover on the other end to integrate; wherein, the middle part of the direct piercing-through hole is hollow-shaped to form two restraining-rings being respectively set at the upper and lower position around; moreover, one open-cutting trench intercommunicating with the direct piercing-through hole is respectively set at the two restraining-rings of the upper and lower position; moreover, one flat-round piercing-through hole and one inner threaded hole are set both sides of the open-cutting trench; the two open-cutting trenches are separated at two positions with different axes. The purpose of avoiding cracking the front fork tube can be reached.

### BACKGROUND OF THE INVENTION

1) Field of the Invention

The present invention relates to an vertical-tube-fixing-base structure of the front fork tube of the bike; the main purpose of the present invention is aimed at providing an vertical-tube-fixing-base, which is designed to be applied on the carbon-fiber-made front fork tube and the direct piercing-through hole of said vertical-tube-fixing-base is mounted on the front fork tube to tightly locked the tube with even force, by means of the open-cutting trenches of the upper and lower restraining-ring being separated at different positions to avoid cracking the front fork tube by over concentrated force during the process that the bolt is bolting into the inner threaded hole from the flat-round piercing-through hole located at the upper and lower position around the direct piercing-through hole. The purpose of avoiding cracking the front fork tube can be reached.

2) Description of the Related Art

The technical level of the industry has been improved substantially, and the material of front fork tube has been improved continuously, e.g. from conventional iron transferred to aluminum, aluminum alloy and carbon fiber, which is extensively adopted nowadays. The frame and accessories have been improved substantially, but the structure of the vertical-tube-fixing-base fabricated on the front fork tube of the bike still need to be improved. Looking at the structure of vertical-tube-fixing-base B currently fabricated on front fork tube A (as shown in FIG. 1-A and FIG. 1-B), direct piercing-through hole B1 is set at one end of vertical-tube-fixing-base B and one open-cutting trench B2 intercommunicating with direct piercing-through hole B1 is respectively set at the upper and lower position outside of vertical-tube-fixing-base B; moreover, one flat-round piercing-through hole and one inner threaded hole are set both sides of straight-line-shaped open-cutting trench B2 (as shown in FIG. 1-B and FIG. 1-C). Hence, install vertical-tube-fixing-base B on front fork tube A of the frame of the bike by bolting bolt C into said flat-round piercing-through hole and inner threaded hole. Then, clip horizontally-arranged handle E via the horizontal-piercing-through hole and fixing-base-cover D on the other end to integrate. However, when fabricating the components, we found that when direct piercing-through hole B1 of vertical-tube-fixing-base B was tightly pressed on front fork tube A and the pressing force was concentrated on the same positions of the two straight-line-shaped open-cutting trenches B2, the pressing positions were easy to be cracked by over concentrated force. The problem needs to be solved urgently.

### SUMMARY OF THE INVENTION

The main purpose of the present invention is providing a structure of vertical-tube-fixing-base and the direct piercing-through hole of said vertical-tube-fixing-base is mounted on the front fork tube of the frame of the bike; wherein, a restraining-ring is respectively set at the upper and lower position around the direct piercing-through hole, and an open-cutting trench intercommunicating with the direct piercing-through hole is respectively set at the upper and lower restraining-ring. Moreover, a flat-round piercing-through hole and an inner threaded hole are set at both sides of the open-cutting trench, and the two open-cutting trenches are separately set at both sides of different axes. Hence, when the direct piercing-through hole of the vertical-tube-fixing-base is mounted on the front fork tube and the bolt is bolting into the inner threaded hole from the flat-round piercing-through hole located at the upper and lower position around the direct piercing-through hole, the restraining-rings can tightly lock the tube with even force to avoid cracking the front fork tube by over concentrated force, since the open-cutting trenches of the upper and lower restraining-rings are designed to be set at different positions. The purpose of avoiding cracking the front fork tube can be reached.

### BRIEF DESCRIPTION OF THE DRAWINGS

Other features and advantages of the present invention will become apparent in the following detailed description of the preferred embodiments, with reference to the accompanying drawings, in which:

FIG. 1-A is a schematic view of the conventional structure.

FIG. 1-B is a 3-D view of the assembled conventional structure.

FIG. 1-C is a cross-section view of the assembled conventional structure.

FIG. 2-A is a 3-D exploded view of the structure of the invention.

FIG. 2-B is a schematic view of the assembly position of the structure of the invention.

FIG. 3 is a schematic view of the cracked front-fork-tube after being assembled.

FIG. 4-A is a cross-section view of the assembled preferred embodiment of the invention.

FIG. 4-B is a schematic view (1) of a portion of the assembled preferred embodiment of the invention.

FIG. 4-C is a schematic view (2) of a portion of the assembled preferred embodiment of the invention.

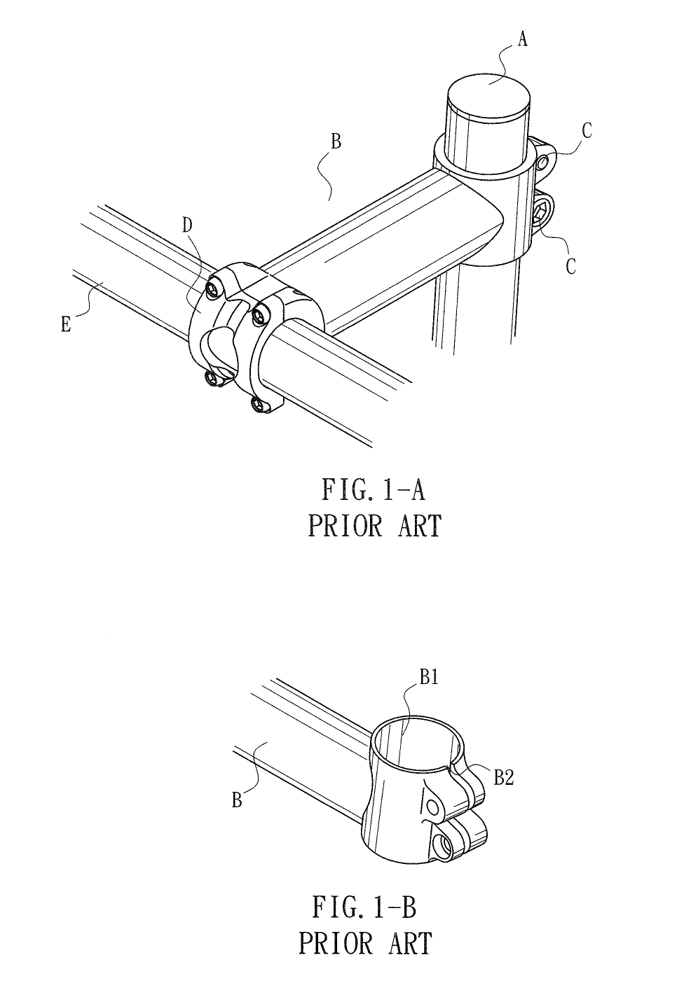

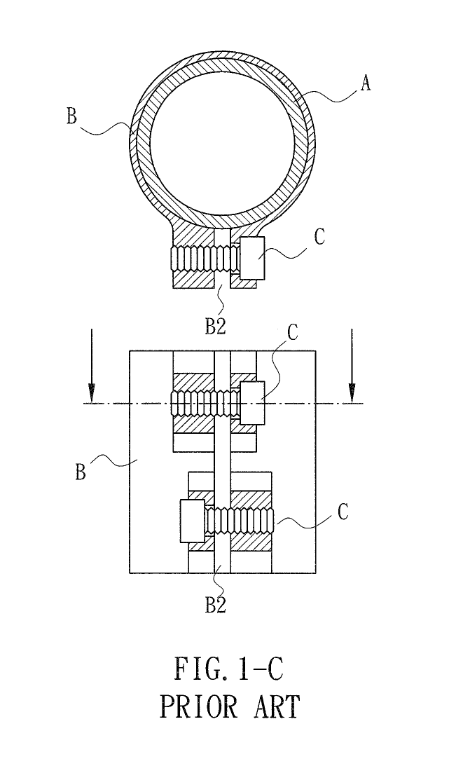

### DETAILED DESCRIPTION OF THE PREFERRED EMBODIMENTS

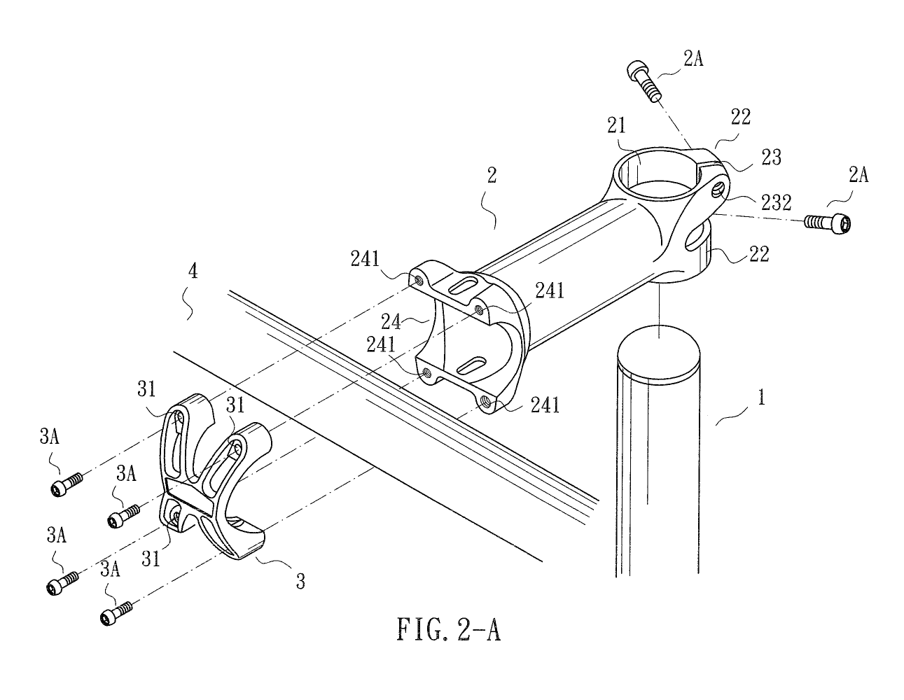

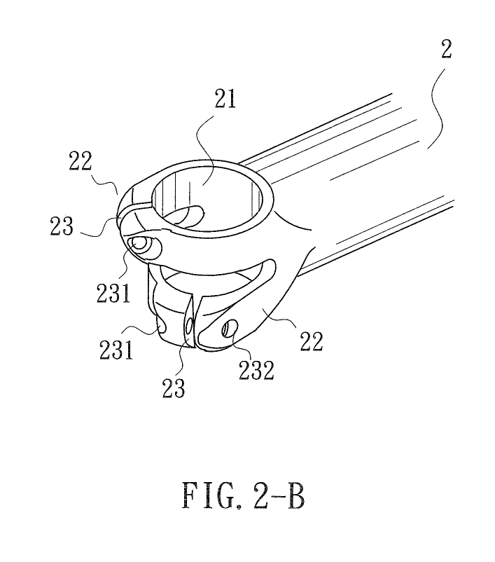

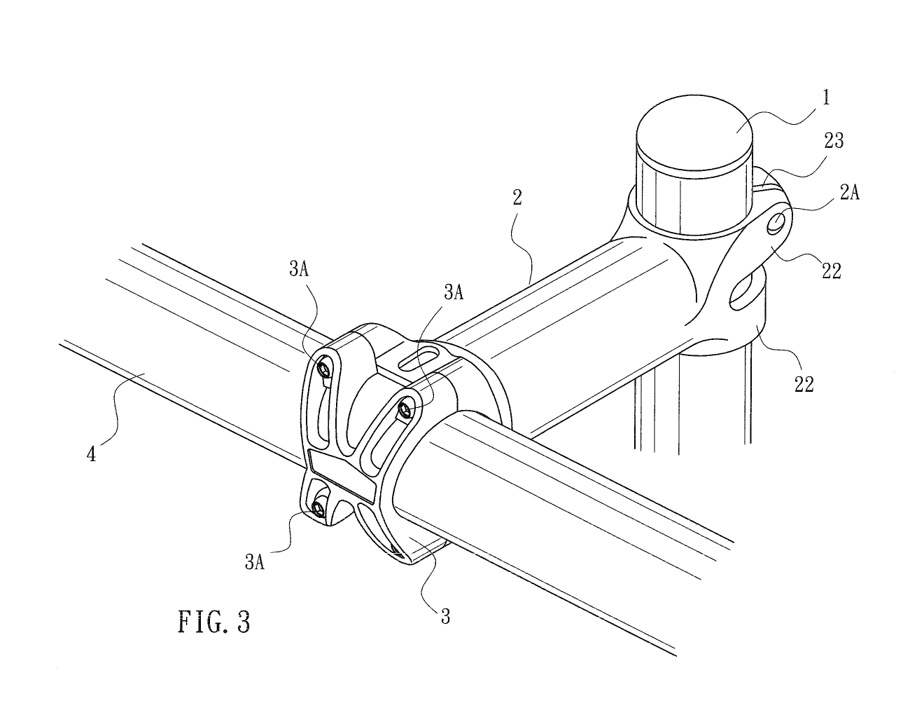

In the detailed description of the preferred embodiments, it should be noted that like elements are indicated by the same reference numerals throughout the disclosure. Please refer to FIG. 2-A and FIG. 2-B; the present invention is related to an vertical-tube-fixing-base structure of the front fork tube of the bike and aimed at providing an vertical-tube-fixing-base 2, which is designed to be applied on the carbon-fiber-made front fork tube 1 and direct piercing-through hole 21 of vertical-tube-fixing-base 2 is mounted on front fork tube 1; then, clip horizontally-arranged handle 4 via fillister 24 and fixing-base-cover 3 on the other end to integrate; wherein, the middle part of direct piercing-through hole 21 of vertical-tube-fixing-base 2 is hollow-shaped to form two restraining-rings being respectively set at the upper and lower position around; moreover, one open-cutting trench 23 intercommunicating with direct piercing-through hole 21 is respectively set at the two restraining-rings 22 of the upper and lower position; moreover, one flat-round piercing-through hole 231 and one inner threaded hole 232 are set both sides of open-cutting trench 23; furthermore, the two open-cutting trenches 23 are separated at two positions of the different axes. In addition, one threaded hole 241 is respectively set at each of the four corners of fillister 24 of vertical-tube-fixing-base 2; place handle 4 into vertical-tube-fixing-base 2 and fix it by bolting blots 3A into piercing-through holes 31 surrounding fixing-base-cover 3 (as shown in FIG. 3).

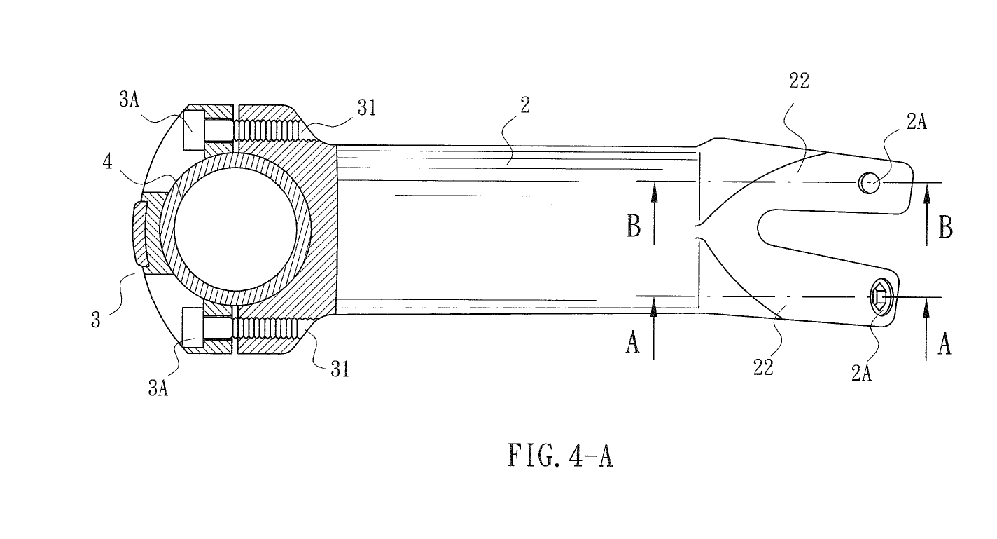

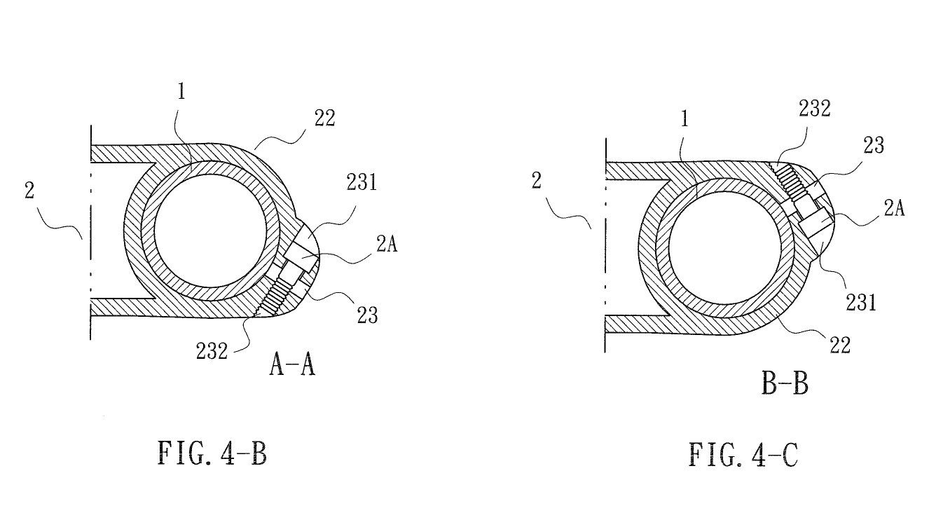

When direct piercing-through hole 21 of vertical-tube-fixing-base 2 is mounted on the front fork tube 1 and bolts 2A are bolted from flat-round piercing-through holes 231 at the upper and lower position around direct piercing-through hole 21 into inner threaded holes 232 (as shown in FIG. 4-A), the upper and lower restraining-rings 22 can tightly lock front fork tube 1 with force evenly applied on open-cutting trenches 23 at different positions to avoid cracking front fork tube 1 by over concentrated force, since the open-cutting trenches 23 of the upper and lower restraining-ring are designed to be set at different positions (as shown in FIG. 4-B, FIG. 4-C). The purpose of avoiding cracking the front fork tube can be reached.

While the description of present invention is made in connection with what is considered the most practical and preferred embodiments, it is understood that this invention is not limited to the disclosed embodiments but intended to cover various arrangements included within the spirit and scope of the broadest interpretations and equivalent arrangements.

What is claimed is:

1. The present invention relates to an vertical-tube-fixing-base structure of the front fork tube of the bike and the direct piercing-through hole of said vertical-tube-fixing-base, which is designed to be mounted on the carbon-fiber-made front fork tube; then, clip the horizontally-arranged handle via the horizontal-piercing-through hole and the fixing-base-cover on the other end to integrate; wherein, the middle part of the direct piercing-through hole is hollow-shaped to form two restraining-rings being respectively set at the upper and lower position around; moreover, one open-cutting trench intercommunicating with direct piercing-through hole is respectively set at the two restraining-rings of the upper and lower position; moreover, one flat-round piercing-through hole and one inner threaded hole are set both sides of the open-cutting trench; the feature is that the two open-cutting trenches are separated at two positions with different axes; hence, when the direct piercing-through hole of the vertical-tube-fixing-base is mounted on the front fork tube and bolts are bolted from the flat-round piercing-through holes at the upper and lower position around the direct piercing-through hole into the inner threaded holes, the upper and lower restraining-rings can tightly lock the front fork tube with force evenly applied on the open-cutting trenches at different positions to avoid cracking the front fork tube by over concentrated force, since the open-cutting trenches of the upper and lower restraining-ring are designed to be set at different positions. The purpose of avoiding cracking the front fork tube can be reached.
